(19) United States
(12) Patent Application Publication
(10) Pub. No.: US 2007/0072602 A1
(43) Pub. Date: Mar. 29, 2007

(54) Automated reply to voice call

(76) Inventors: Radha J. Iyer, San Jose, CA (US); Nidhi Narang, Fremont, CA (US); Manisha Sahasrabudhe, Santa Clara, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/233,333

(22) Filed: Sep. 21, 2005

(51) Int. Cl. H04Q 7/20

(52) U.S. Cl. 455/426.1

(57) ABSTRACT

Some embodiments provide reception of a voice call and associated caller information, presentation of one or more selectable predetermined responses to the voice call, reception of a selection of one of the predetermined responses, and transmission of the selected predetermined response using the caller information. According to some embodiments, the selected predetermined response is a text message and/or the voice call may be received from a voice mailbox. The selected predetermined response is a voice message in some embodiments.

### BACKGROUND

1. Field

Embodiments may generally relate to responding to voice calls. More particularly, some embodiments are concerned with efficiently responding to voice calls using selectable predetermined responses.

2. Description

Telephone communication is increasingly pervasive in today's society. For example, many people view their mobile cellular telephone as a required daily accessory. The geographic coverage of cellular telephone networks continues to expand as well. Accordingly, a typical person may be reached by telephone at almost any point of her day.

The foregoing circumstances occasionally result in telephone calls that are received at inopportune moments, such as during a quiet performance, during a meeting, or while driving. Currently, a called party who cannot or does not wish to answer such a call may silence a ring caused by the call and make a physical or mental note to deal with the call at a future time. The calling party, on the other hand, is offered an opportunity to leave a voice message in a voice mailbox associated with the called party, but receives no indication of whether the call was noticed by the called party.

Text messaging has emerged as a popular form of communication. Text messages may be transmitted using an Instant Messaging (IM) protocol, a Short Message Service (SMS) protocol, or other conventional text messaging protocols. In one text messaging scenario, a user inputs text into a cellular telephone using a keypad and operates the cellular telephone to transmit the text to a remote user. The cellular telephone uses a text messager to transmit the text to the remote user. The message is received by a cellular telephone of the remote user, who then operates his cellular telephone to display the text message.

Systems are desired that may leverage one or more currently-available telephone capabilities to provide improved communication.

### SUMMARY

Some embodiments provide a system, method, program code and/or means to receive a voice call and associated caller information, present one or more selectable predetermined responses to the voice call, receive a selection of one of the predetermined responses, and transmit the selected predetermined response using the caller information. In some aspects, the caller information is a telephone number of a caller from whom the voice call is received, and the predetermined response is a text message. The voice call may be received from a voice mailbox according to further aspects.

Embodiments may also provide a voice call receiver to receive a voice call and associated caller information, a user interface to present one or more selectable predetermined responses to the voice call, and to receive a selection of one of the predetermined responses, and a response transmitter to transmit the selected predetermined response using the caller information.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram of a system according to some embodiments;

FIG. 2 is a flow diagram of a process according to some embodiments;

FIG. 3 is an outward view of a telephone according to some embodiments;

FIG. 4 is a block diagram of the internal architecture of a telephone according to some embodiments;

FIG. 5 is a block diagram of a telephone operating system according to some embodiments;

FIG. 6 is a block diagram of the software architecture of a telephone according to some embodiments;

FIG. 7 is a flow diagram of a process according to some embodiments;

FIG. 8 is an outward view of a telephone according to some embodiments;

FIG. 9 is an outward view of a telephone according to some embodiments;

FIG. 10 is a flow diagram of a process according to some embodiments;

FIG. 11 is an outward view of a telephone according to some embodiments;

FIG. 12 is a flow diagram of a process according to some embodiments;

FIG. 13 is an outward view of a telephone according to some embodiments; and

FIG. 14 is a diagram of a system architecture according to some embodiments.

### DETAILED DESCRIPTION

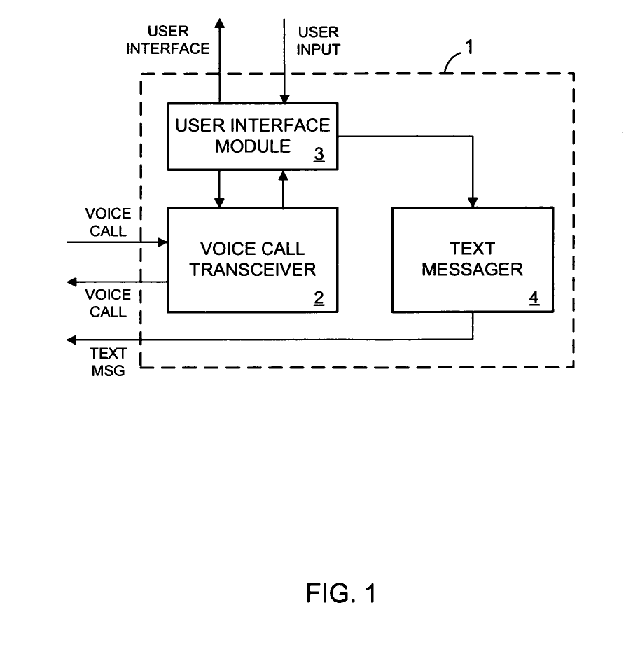

FIG. 1 is a block diagram of device 1 according to some embodiments. Device 1 may receive a voice call and associated caller information, present one or more selectable predetermined responses to the voice call, receive a selection of one of the predetermined responses, and transmit the selected predetermined response using the caller information. In some embodiments, the voice call is received from a voice mailbox provider.

Device 1 may comprise a portable device or a fixed device, the latter including but not limited to a “land line” telephone. Examples of portable devices include cellular telephones, personal digital assistants (PDAs), digital media players, digital cameras, wireless email devices, and any other device for receiving voice calls that is or becomes known.

Device 1 includes voice call transceiver 2, user interface module 3, and text messager 4. Each element of device 1 may comprise any combination of hardware and/or software components suitable for providing the functions attributed thereto herein. Two or more of transceiver 2, user interface module 3, and text messager 4 may share one or more constituent components, and, in some embodiments, device 1 may include unshown elements for providing the functions described herein.

Voice call transceiver 2 may receive and transmit voice calls via any suitable protocol. Voice call transceiver 2 may also receive caller information associated with received voice calls. The caller information may comprise caller ID information and/or any other information that device 1 may use to provide a response to a party from whom a voice call is received. Voice call transceiver 2 may also transmit a predetermined voice message in response to user selection of the predetermined voice message.

The user selection may be transmitted to voice call transceiver 2 by user interface module 3. In this regard, voice call transceiver 2 may notify module 3 of the reception of the voice call. User interface module 3 may present a user interface to a user in response to the notification. The user interface, examples of which are described below, may present one or more selectable predetermined responses to the received voice call.

User interface module 3 may receive user input indicating a selected one of the predetermined responses from the user interface or from another input element of device 3. In a case that the selected predetermined response is a voice call, voice call transceiver 2 may be instructed to transmit the selected predetermined response using the caller information associated with the received voice call.

User interface module 3 may alternatively instruct text messager 4 to transmit a text message in a case that the selected predetermined response is a text message. In response, text messager 4 transmits a text message using the aforementioned caller information and a suitable text messaging service. The text messaging service may comprise any currently- or hereafter-known text messaging service. Conventional examples include IM, SMS, Multimedia Message Service (MMS), Enhanced Message Service (EMS), and electronic mail.

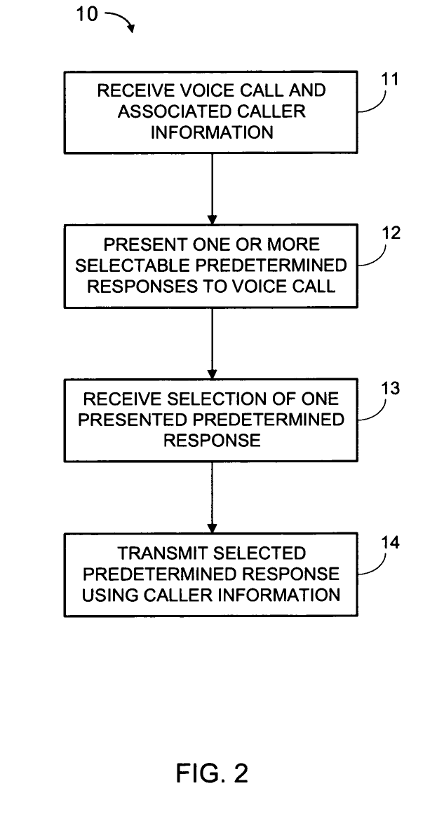

FIG. 2 is a flow diagram of process 10 according to some embodiments. Process 10 may be executed by device 1 using any suitable hardware and/or software arrangement, and process 10 may be executed by any suitable device or devices that are or become known.

A voice call and associated caller information are initially received at 11. The received voice call may comprise signals representing a request to initiate a voice call connection, and which cause the receiving device to ring, vibrate, and/or perform any other actions that are appropriate upon receiving a request to initiate a voice call. The voice call may be received via any suitable protocol, including but not limited to Time Division Multiple Access (TDMA) (e.g., GSM, D-AMPS), Code Division Multiple Access (CDMA), and CDMAOne (e.g., PCS), as well as non-cellular voice call protocols. The associated caller information may comprise any information that may be transmitted via the employed protocol, and that may be used to transmit a response to the party from whom the voice call is received (e.g., caller ID information).

As mentioned above, the voice call may be received at 11 after accessing a voice mailbox and interacting with a voice mailbox service to initiate playback of a voice call stored in the voice mailbox. In this regard, the voice mailbox service may transmit the voice call and the associated caller information for reception at 11.

One or more selectable predetermined responses to the received voice call are presented at 12. The selectable predetermined responses may be presented to a user via any media that may be perceived, including visual, aural, and/or tactile media. In some embodiments, the responses are presented by a display. The selectable predetermined responses may comprise one or more text messages, one or more voice messages, or a combination thereof. The responses may be predetermined by factory settings and/or customizable by a user. Detailed examples of predetermined responses according to some embodiments are provided below.

Next, at 13, a selection of one of the presented predetermined responses is received. The selection may be received via a user interface that was used to present the predetermined responses (e.g., a touch screen) or from another input device such as a keypad, microphone, etc.

The selected predetermined response is transmitted using the previously-received caller information at 14. In a case that the selected predetermined response is a voice call, the selected predetermined response is transmitted via a suitable voice call protocol and using the caller information received at 11. In a case that the selected predetermined response is a text message, a suitable text messaging service is employed to transmit the selected text message using the received caller information.

Some embodiments of the FIG. 1 system and/or the FIG. 2 process provide more efficient communication than previously available.

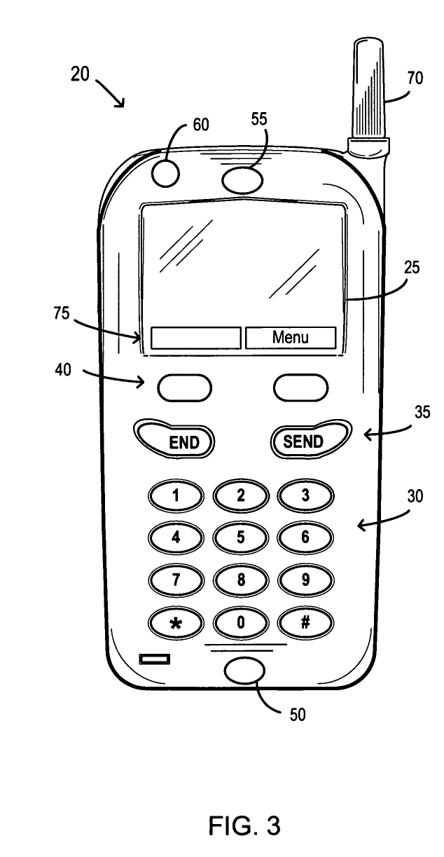

FIG. 3 is a schematic front elevation view of portable cellular telephone 20. Cellular telephone 20 may comprise device 1 of FIG. 1 and/or may execute process 10 according to some embodiments. Cellular telephone 20 may include conventional components, and may include program code for performing certain functions described herein. Embodiments may differ in part or in whole from cellular telephone 20.

Cellular telephone 20 may be compatible with one or more cellular communication protocols, including but not limited to those mentioned above. As also mentioned above, some embodiments operate in conjunction with non-cellular and/or non-portable devices and their associated protocols.

Cellular telephone 20 includes display 25, keypad 30, fixed function keys 35, variable function keys 40, microphone 50, speaker 55, power button 60 and antenna 70. Display 25 displays a user interface for accessing the functionality of telephone 20. Alphanumeric keypad 30 is laid out as a conventional telephone dialing keypad, and fixed function keys 35 are used, respectively, to initiate a communication and to terminate a communication. Variable function keys 40 provide functions that vary in accordance with function labels 75 displayed on display 24 above keys 40.

Microphone 50 receives audio signals that may represent speech of a user. The signals may be stored as voice messages to be selectively transmitted in response to a received voice call according to some embodiments described herein. In some embodiments, the audio signals may comprise commands for operating telephone 20, such as a command to select a presented predetermined response.

Speaker 55 emits audio signals from telephone 20. The audio signals may comprise ring tones, beeps and other tones used during operation of telephone 20, and/or speech or other audio signals received from another device such as another telephone. Speaker 55 may also emit audio signals representing speech or other sounds received by microphone 50.

Power button 60 may be used to turn cellular telephone 20 on and off. Antenna 70 may receive and transmit radio frequency signals from and to a cellular telephone network. Antenna 70 may be configured to transmit and receive any types of signals that comply with the communication protocol of the communication network in which telephone 20 is employed.

In some examples of operation, antenna 70 receives signals of a voice call transmitted to a telephone number associated with telephone 20. The signals may comprise signals to initiate a voice call with telephone 20. The signals may also comprise caller information associated with the voice call. In response to the received signals, microphone 55 emits a ringtone and display 25 presents a user interface. The user interface includes one or more predetermined responses and associates each response with a number. A user then selects one of the predetermined responses by depressing a key of keypad 30 whose number is associated with the one predetermined response.

The response is then transmitted via antenna 70. In embodiments where the response is a voice message, telephone 20 may answer the received voice call to initiate the voice call and then transmit the voice message to the caller. Telephone 20 may then terminate the voice call by transmitting a termination request to a cellular service provider via antenna 70. According to some embodiments, the received voice call is first terminated and a new voice call is initiated by telephone 20 using the caller information received with the original voice call.

If the selected predetermined response is a text message, telephone 20 may terminate the received voice call and operate to transmit the text message. The text message may be transmitted via antenna 70 also using the caller information that was received with the voice call.

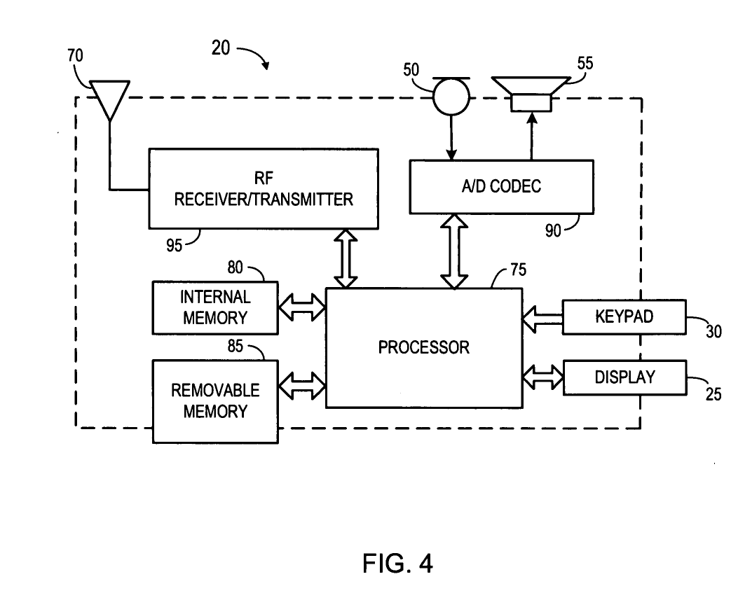

FIG. 4 is a block diagram of the internal architecture of cellular telephone 20 according to some embodiments. As shown, cellular telephone 20 includes processor 75, which may be a conventional microprocessor, microcontroller and/or digital signal processor (DSP) or other control circuit conventionally provided in a cellular telephone. Processor 75 is shown in communication with keypad 30 and display 25 for control thereof.

Also included in the cellular telephone 20 are internal memory 80 and removable memory 85. Internal memory 80 may include one or more of ROM (read only memory), RAM (random access memory, e.g., static RAM), and flash memory. Removable memory 85 may comprise a flash memory, a Subscriber Identity Module (SIM) card or any other removable memory that is or becomes known. Cellular telephone 20 may therefore be equipped with an interface for physically receiving and transferring data to and from removable memory 85.

Memories 80 and 85 may store program code that is executable by processor 75 to control telephone 20. The program code may include but is not limited to operating system program code, application program code, device driver program code, and database connector program code. The program code may include code to cause telephone 20 to perform functions that are described herein. In some embodiments, the program code is executable to provide a voice call transceiver, a user interface module and a text messager as described with respect to FIG. 1.

Memories 80 and 85 may also store data used in the operation of cellular telephone 20. Such data may include phone numbers, addresses, access codes, stored audio files, text corresponding to the stored audio files, and other data. Some or all of the data may be read-only, while other of the data may be rewritable.

Analog/digital coder/decoder (A/D codec) 90 is also in communication with processor 75. A/D codec 90 may receive analog signals from microphone 50, convert the analog signals to digital signals, and pass the digital signals to processor 75. Conversely, processor 75 may transmit digital signals to A/D codec 90, which converts the digital signals to analog signals and passes the analog signals to speaker 55. Speaker 55 then emits sound based on the analog signals.

RF receiver/transmitter 95 is operatively coupled to antenna 70. RF receiver/transmitter 95 may, in accordance with conventional practices, comprise a combination of two or more different receive/transmit modules (not separately shown) that operate in accordance with mutually different radio communication protocols to provide various services for the cellular telephone 20. For example, receiver/transmitter 95 may operate in accordance with one radio communication protocol to provide conventional two-way service for cellular telephone 20, and may operate in accordance with another radio communication protocol to provide PoC service for cellular telephone 20.

Those in the art will understand that the block diagram of FIG. 4 is simplified in a number of ways. For example, all power and power management components of cellular telephone 20 are omitted from the diagram. Also, some embodiments may employ an internal architecture somewhat different or completely different from that shown in FIG. 4.

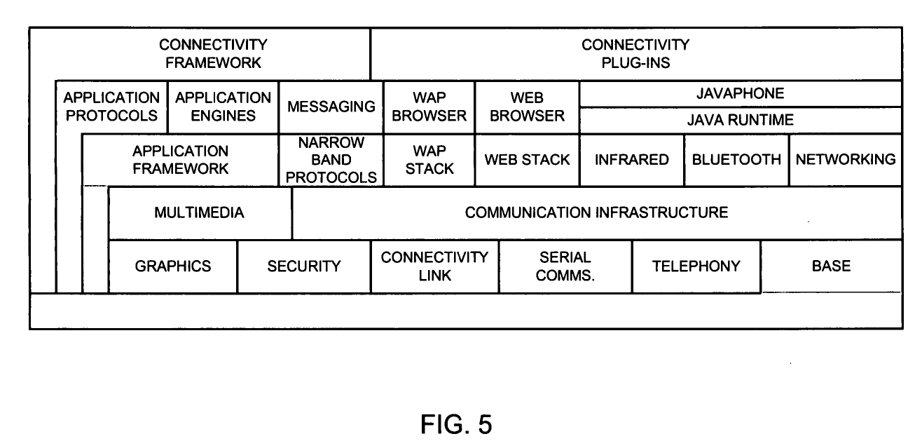

FIG. 5 is a block diagram of an operating system architecture that may be used in conjunction with some embodiments. Architecture 100 corresponds to the Symbian™ cellular telephone operating system. Any suitable operating system may be used in conjunction with some embodiments, including those not intended and/or usable with cellular telephones. Suitable operating systems according to some embodiments include but are not limited to Palm OS™, Windows CE ™, and operating systems suitable for devices capable of transmitting text messages (e.g., landline telephones, PDAs, digital media players).

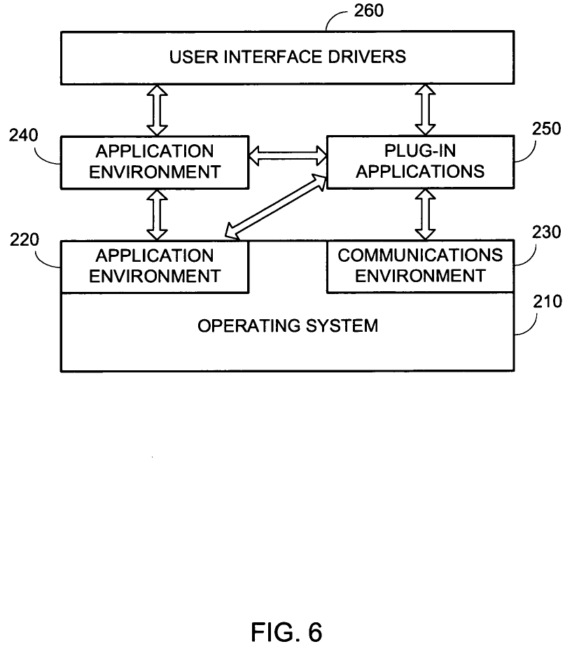

FIG. 6 is a block diagram of a general software architecture that may be used within cellular telephone 20 in conjunction with some embodiments. Architecture 200 may operate to receive a voice call and associated caller information, present one or more selectable predetermined responses to the voice call, receive a selection of one of the predetermined responses, and transmit the selected predetermined response using the caller information.

Architecture 200 includes operating system 210, which may comprise architecture 100 of FIG. 5. In such a case, application environment 220 and communications environment 230 may correspond, respectively, to the connectivity framework and the connectivity plug-ins of architecture 100. Generally, application environment 220 provides a platform by which another application environment 240 may interface with operating system 210. Application environment 240 may comprise a Java™ or C programming environment. As such, plug-in applications 250 may be written in Java or C for execution by cellular telephone 20. Plug-in applications 250 may also be written for the application interface provided by application environment 220.

Communications environment 230 provides plug-in applications 250 with access to the communications functionality of operating system 210. This functionality may include text messaging, Web browsing and of course telephone communication. Plug-in applications 250 may also transmit data and commands to and receive input from user interface drivers 260 for control of the user interfaces of telephone 20.

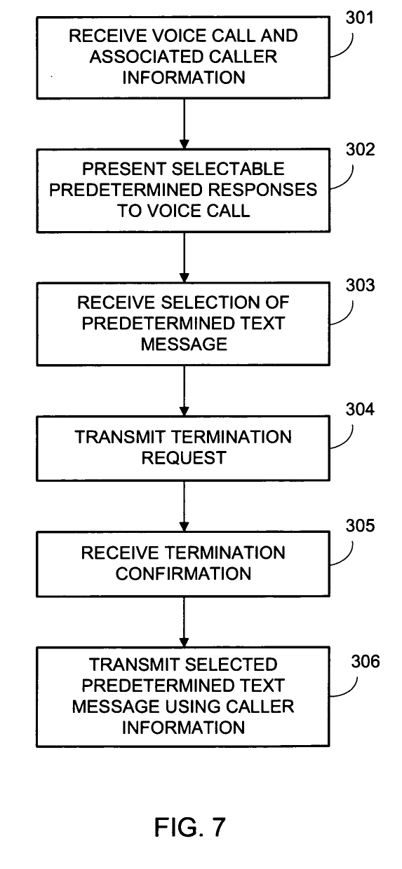

FIG. 7 is a flow diagram of process 300 according to some embodiments. Process 300, as well as each other process described below, may be embodied in hardware and/or software of device 1, telephone 20, or one or more other suitable devices. In the foregoing description, the processes will be described as if embodied in program code of one of plug-in applications 250. As described above, such program code may be executable within a multi-platform environment such as application environment 240 and/or within the environment provided by application environment 220. The described processes may also or alternatively be embodied in native program code of telephone 20.

Initially, at 301, a voice call and associated caller information are received. The voice call and caller information may be received from a telephone network, including but not limited to a packet-switched telephone network and a cellular network. It will be assumed in the present example that the received voice call comprises a request to initiate a voice call connection that complies with a voice call protocol supported by the receiving device. The associated caller information may comprise any information that may be transmitted via the employed voice call protocol, and that may be used to transmit a response to the party from whom the voice call is received.

According to some embodiments in which the voice call and associated caller information are received from a cellular telephone via the GSM (Global System for Mobile Communications) protocol, a Radio Resource connection is established between the cellular telephone and a suitable Mobile Switching Center. The cellular telephone and Mobile Switching Center exchange signaling messages, with a Base Station System acting as a conduit therebetween.

The signaling messages may include a call control Setup message from the cellular telephone to the Mobile Switching Center consisting in part of a telephone number of an intended receiving device. The call control Setup message is passed from the Mobile Switching Center through a Base Station System and on to the receiving device. The Mobile Switching Center may then receive a call control Call Confirmed message from the receiving device via the Base Station System and pass a corresponding call proceeding message to the cellular telephone

Depending on settings of the receiving device, the incoming voice call may cause the device to ring, vibrate, and/or otherwise present an indication of the voice call. The device may also transmit a call control Alerting message to the cellular telephone by way of the intermediaries mentioned above. In response, the cellular telephone may indicate to the calling party that the receiving device is in an alerting mode.

Next, at 302, the receiving device presents one or more selectable predetermined responses to the received voice call. Display 25 displays the selectable predetermined responses according to the present example. As mentioned above, the selectable predetermined responses may comprise one or more text messages, one or more voice messages, or a combination thereof.

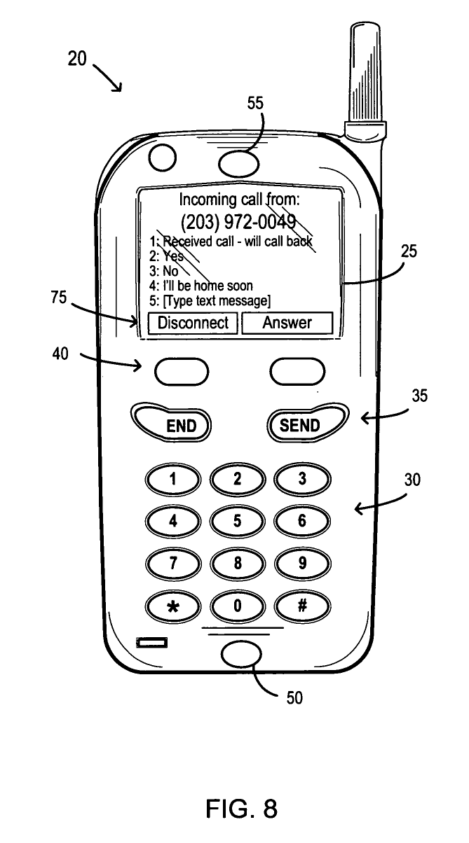

FIG. 8 is an outward view of telephone 20 at 302 according to some embodiments. Display 25 presents several predetermined responses. According to the present example of process 300, each of the presented responses is a text message. One or more of the predetermined responses may be programmed during fabrication of telephone 20, and one or more of the responses may be programmed by a user prior to process 300.

A selection of one of the presented predetermined text messages is received at 303. According to some embodiments, the selection is received by detecting the depression of a key of keypad 30 and identifying a text message that is associated with the number of the depressed key. Referring to the FIG. 8 example, a user may depress key 1 of keypad 30 after 302, and, as a result, a selection of the “Received Call—will call back” text message is received at 303. As mentioned above, a selection of a presented predetermined response may be input and received using any suitable system that is or becomes known.

A termination request is transmitted in response to the received selection at 304. The termination request is intended to disconnect the received voice call. Accordingly, the termination request may comprise any signal or signals suitable to disconnect the incoming voice call in view of the employed communication protocol.

Continuing with the previous example, telephone 20 may transmit a call control Disconnect signal at 304. The signal may pass through a Base Station System, a Mobile Switching Center, and another Base Station System to the calling device.

Next, at 305, a confirmation is received. The confirmation confirms that the incoming voice call has been terminated. Termination may comprise ceasing to transmit signals associated with the voice call to telephone 20, transmission of a termination signal to a telephone that initiated the voice call, and/or any other suitable event(s). According to some embodiments, the confirmation comprises a call control Release signal transmitted from a Mobile Switching Center. Telephone 20 may transmit a call control Release Complete signal in response according to some embodiments.

After the confirmation has been received, the selected predetermined text message is transmitted at 306 using the caller information received at 301. According to some embodiments of 306, telephone 20 invokes a text messager to transmit the selected text message according to any currently- or hereafter-known protocol. The text message is transmitted to the caller identified by the received caller information.

The caller information may comprise caller ID information or other caller-identifying information. For example, the caller information may comprise a name of a caller from whom the voice call was received, and telephone 20 may determine a telephone number associated with the caller based on an address book stored therein. The identified telephone number may then be used to transmit the predetermined text message.

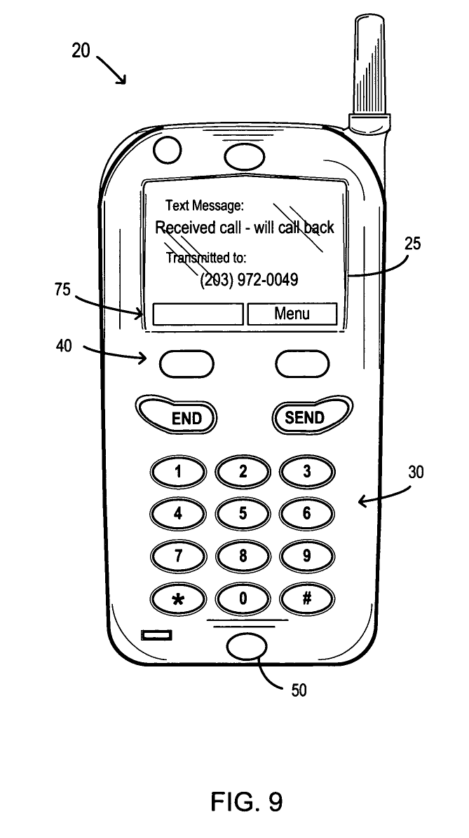

FIG. 9 is an outward view of telephone 20 after 306 of process 300. Display 25 presents the transmitted message as well as information identifying the party to which the message was transmitted. In some embodiments, the message and information are presented for a specified time or until the user selects variable function key 40 that is associated with “Menu” function label 75.

Some embodiments of process 300 may proceed from 303 directly to 306. Such embodiments may allow the incoming voice call to proceed normally (e.g., transfer to a voice mailbox or to another telephone number) while independently transmitting the text message. According to some embodiments of process 300, the selected predetermined response is a voice message. The voice message may be transmitted at 306 by initiating a voice call using the caller information, transmitting the voice message when the voice call is established (e.g., the called party answers the voice call, the voice call is answered by a voice mailbox service, etc.), and terminating the voice call.

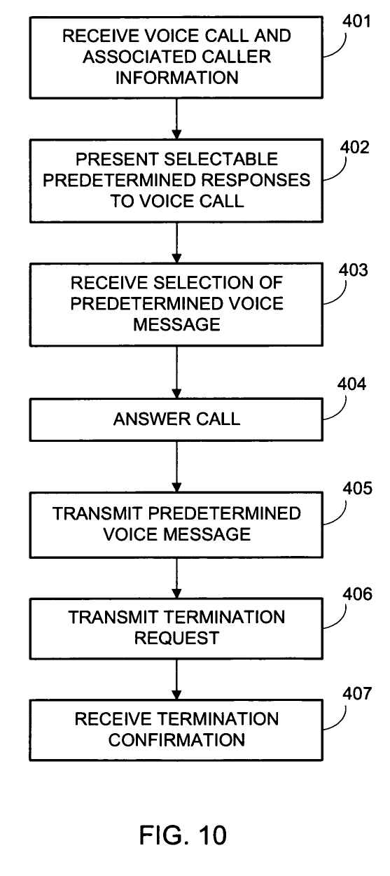

FIG. 10 is a flow diagram of process 400 according to some embodiments. Embodiments according to process 400 are generally directed to answering an incoming voice call and transmitting a predetermined voice message to a calling party within the answered voice call.

A voice call and associated caller information are initially received at 401, and selectable predetermined responses to the voice call are presented at 402. In this regard, 401 and 402 may proceed as described above. In the present example, the selectable predetermined responses include at least one voice message.

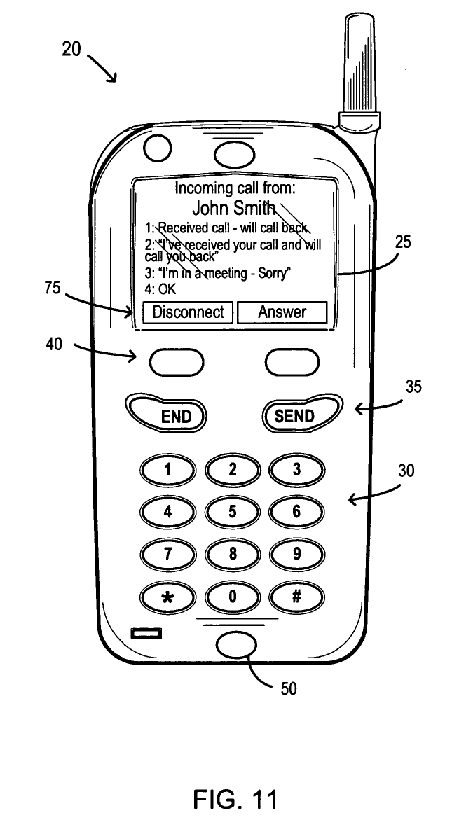

FIG. 11 is an outward view of telephone 20 at 402 according to some embodiments. Display 25 presents several predetermined responses. The responses in quotation marks are voice messages, and the other responses are text messages. Any other suitable system to present predetermined responses may be used according to some embodiments.

A selection of a presented predetermined voice message is received at 403. According to the present example, a user depresses key 2 of keypad 30 at 403, and, as a result, telephone 20 receives a selection of the “I've received your call and will call you back” voice message. Again, the selection of a presented predetermined response may be input and received using any suitable system that is or becomes known.

The voice call is answered at 404. Telephone 20 may answer the voice call using any suitable signals or protocols. In some embodiments, telephone 20 transmits a “connect” message to a cellular network from which the call was received, which prompts the network to establish two-way voice communication between a calling device and telephone 20.

Next, at 405, the predetermined message is transmitted. The message may be transmitted in any format that is audible to the calling party. The transmitted message may comprise computer-generated voice signals and/or recorded voice signals. The voice signals may represent the voice of a user of telephone 20 or any other person. The voice signals may be stored in memories 80 and/or 85 any reproducible format.

The voice message may be transmitted at 405 in the same manner as conventional voice signals received by microphone 50 are transmitted during a voice call. In other words, the calling party may hear the voice call being answered and then hear the predetermined voice message. According to some embodiments of 405, any audio signals received by microphone 50 are ignored or otherwise suppressed so as not to interfere with the calling party's comprehension of the transmitted voice message.

A termination request is then transmitted at 406. The termination request is intended to disconnect the received voice call and therefore may comprise any signal or signals suitable to disconnect the incoming voice call. A confirmation of the termination is received at 407.

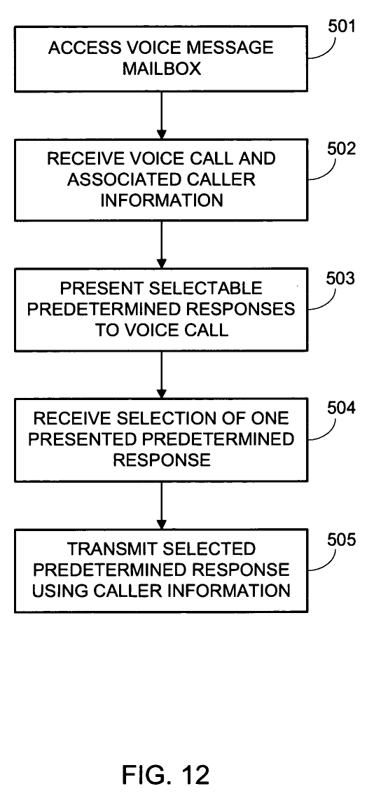

FIG. 12 is a flow diagram of process 500. Process 500 reflects embodiments in which an incoming voice call and associated caller information are received by accessing a voice message mailbox, and a selected predetermined response to the voice call is transmitted.

In particular, a voice message mailbox is accessed at 501 to retrieve a stored voice call. In some embodiments, the mailbox is accessed by operating telephone 20 to dial an access number of a voice mailbox provider and to input a password associated with the voice message mailbox. Any suitable mailbox provider and/or system to access stored voice messages may be used at 501.

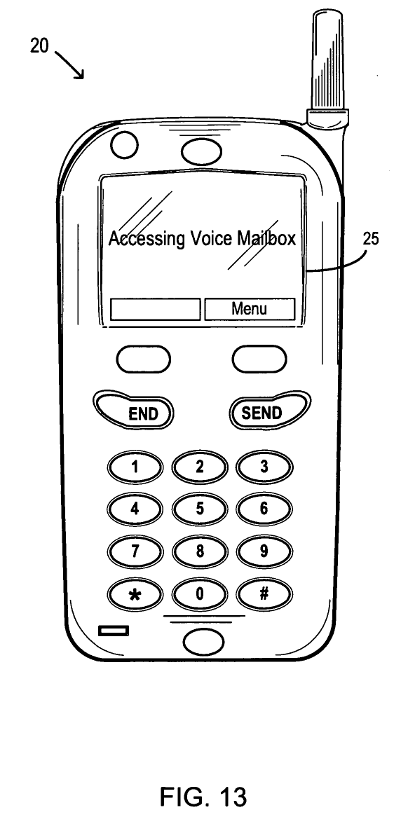

FIG. 13 shows an outward view of telephone 20 according to some embodiments of 501. Display 25 presents text indicating that a voice mailbox is being accessed. The text may be displayed while the access number is being dialed and/or after the password has been successfully entered to gain access to the voice mailbox. Although telephone 20 of FIG. 13 is aware that the dialed access number is associated with a voice mailbox, embodiments are not limited thereto.

The voice mailbox provider may present audible menus to the user of telephone 20 for accessing newly-received and/or stored voice messages. These menus or any other system to access the stored voice messages are utilized at 502 to receive a voice call (i.e., a stored voice message) and associated caller information. The associated caller information may comprise any information that may be used to transmit a response to the party who left the voice call.

According to some embodiments, the caller information (e.g., caller ID information) is transmitted by the voice mailbox provider to telephone 20 along with the voice call using any suitable protocol that is or becomes known. In some embodiments, the caller information comprises a timestamp indicating a time at which the voice call was stored in the voice mailbox. In this regard, telephone 20 may store a “missed call” list that associates caller ID information of unanswered calls with a timestamp indicating when the calls were placed. Accordingly, telephone 20 may determine caller ID information associated with a stored voice call based on a timestamp received from the voice mailbox provider.

One or more selectable predetermined responses to the received voice call are presented at 503. The presentation may occur while or after the voice call is received and heard. The selectable predetermined responses may be presented by display 25 and may comprise one or more text messages, one or more voice messages, or a combination thereof. FIG. 8 illustrates telephone 20 at 503 according to some embodiments.

A selection of one of the presented predetermined responses is then received at 504. The selection may be received by detecting the depression of a key of keypad 30 and identifying a response that is associated with the number of the depressed key. As mentioned above, a selection of a presented predetermined response may be input and received using any suitable system that is or becomes known.

Next, at 505, the selected predetermined response is transmitted using the caller information received at 502. In a case that the predetermined response is a voice message, telephone 20 may instruct the voice mailbox provider to initiate a new telephone call using the caller information. According to some embodiments of 505, the call to the mailbox provider is terminated and telephone 20 initiates a new telephone call using the caller information. After the new call is established, the call is transferred to telephone 20, and telephone 20 transmits the voice message as described with respect to 405 of process 400. In a case that the selected predetermined response is a text message, the text message may be transmitted while the call to the voice mailbox provider is active or after terminating the call.

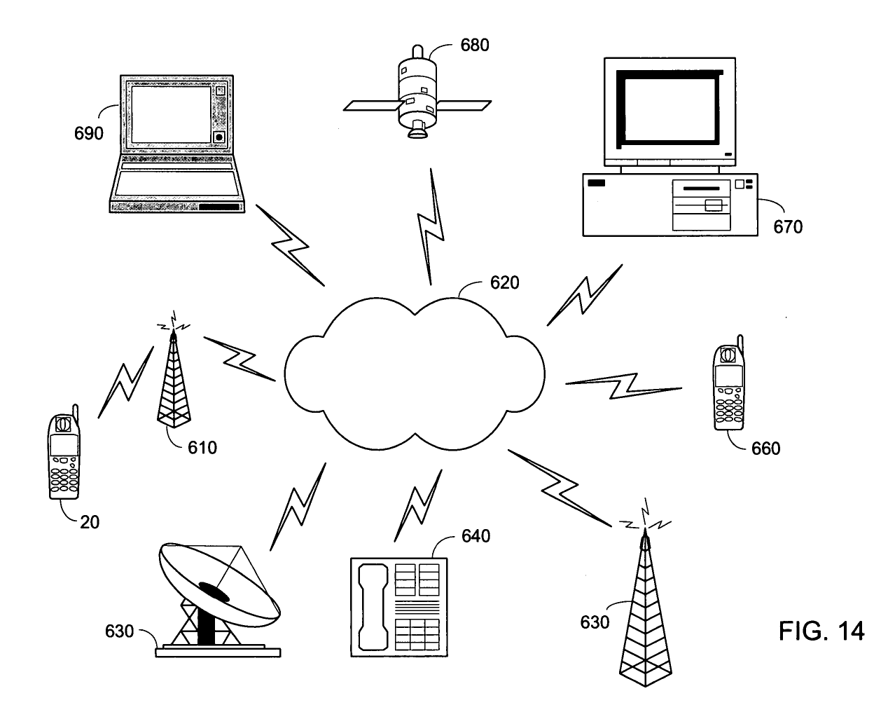

The above-mentioned signals, voice calls, voice messages and text messages may pass through any number of networks, devices and protocols before reaching their intended recipient. FIG. 14 is a partial diagram of a communication architecture 600 according to some embodiments..

Cellular telephone 20 is shown in communication with tower 610. Tower 610 may receive the transmission directly from antenna 70, and may forward the transmission to communication network 620 according to governing protocols. Communication network 620 may include any number of devices and systems for transferring data, including but not limited to local area networks, wide area networks, telephone networks, cellular networks, fiber-optic networks, satellite networks, infra-red networks, radio frequency networks, and any other type of networks which may be used to transmit information between devices. Additionally, data may be transmitted through communication network 620 using one or more currently- or hereafter-known network protocols, including but not limited to Asynchronous Transfer Mode (ATM), Internet Protocol (IP), Hypertext Transfer Protocol (HTTP) and Wireless Application Protocol (WAP).

Devices 630 through 690 are examples of some devices that may be a part of or in communication with communication network 620. As such, devices 630 through 690 may receive text or voice messages, either as intended recipients or as network nodes for passing messages. Devices 630 through 690 include satellite transmitter/receiver 630, landline telephone 640 having a telephone line interface to receive a telephone line (e.g., a cordless phone or a corded phone), communication tower 650, cellular telephone 660, desktop computer 670, satellite 680 and laptop computer 690. Any other suitable devices may be used as a transmitting device or a receiving device in conjunction with some embodiments.

The elements of system 600 may be connected differently than as shown. For example, some or all of the elements may be connected directly to one another. Embodiments may include elements that are different from those shown. Moreover, although the illustrated communication links between the elements of system 600 appear dedicated, each of the links may be shared by other elements. Elements shown and described as coupled or in communication with each other need not be constantly exchanging data. Rather, communication may be established when necessary and severed at other times or always available but rarely used to transmit data.

In some embodiments, the aforementioned incoming voice call is transmitted by cellular telephone 660. Accordingly, cellular telephone 660 is associated with the caller information received with the voice call. Moreover, cellular telephone 660 receives the voice or text message transmitted according to some embodiments described above.

Embodiments described above are not intended to be limited to the specific form set forth herein, but are intended to cover such alternatives, modifications and equivalents as can reasonably be included within the spirit and scope of the appended claims.

What is claimed is:

1. A method, comprising:
receiving a voice call and associated caller information;
presenting one or more selectable predetermined responses to the voice call;
receiving a selection of one of the predetermined responses; and
transmitting the selected predetermined response using the caller information.

2. A method according to claim 1, wherein the caller information is a telephone number of a caller from whom the voice call is received.

3. A method according to claim 1, wherein the predetermined response is a text message.

4. A method according to claim 3, wherein the one or more selectable predetermined responses comprise one or more text messages.

5. A method according to claim 4, wherein the one or more selectable predetermined responses comprise one or more voice messages.

6. A method according to claim 4, further comprising:
transmitting a termination request; and
receiving a confirmation of the termination request before transmitting the predetermined response.

7. A method according to claim 1, wherein the predetermined response is a voice message.

8. A method according to claim 7, further comprising:
answering the voice call,
wherein the predetermined response is transmitted while the voice call is active.

9. A method according to claim 1, further comprising:
accessing a voice mailbox to receive the voice call.

10. A method according to claim 9, further comprising:
transmitting a termination request; and
receiving a confirmation of the termination request before transmitting the predetermined response.

11. A method according to claim 9, wherein the predetermined response is a text message.

12. A method according to claim 11, wherein the one or more selectable predetermined responses comprise one or more text messages.

13. A method according to claim 12, wherein the one or more selectable predetermined responses comprise one or more voice messages.

14. A method according to claim 9, wherein the predetermined response is a voice message.

15. A telephone comprising:
a voice call receiver to receive a voice call and associated caller information;
a user interface to present one or more selectable predetermined responses to the voice call, and to receive a selection of one of the predetermined responses; and
a response transmitter to transmit the selected predetermined response using the caller information.

16. A telephone according to claim 15, wherein the caller information is a telephone number of a caller from whom the voice call is received.

17. A telephone according to claim 15, wherein the response transmitter is a text messager and the predetermined response is a text message.

18. A telephone according to claim 17, wherein the one or more selectable predetermined responses comprise one or more text messages.

19. A telephone according to claim 18, wherein the one or more selectable predetermined responses comprise one or more voice messages.

20. A telephone according to claim 17, wherein the response transmitter is to transmit a termination request, and
wherein the voice call receiver is to receive a confirmation of the termination request before transmitting the predetermined response.

21. A telephone according to claim 15, wherein the predetermined response is a voice message.

22. A telephone according to claim 21, wherein the voice call receiver is to answer the voice call, and
wherein the response transmitter is to transmit the predetermined response while the voice call is active.

23. A telephone according to claim 15, wherein the voice call receiver is to access a voice mailbox to receive the voice call.

24. A telephone according to claim 23, wherein the response transmitter is to transmit a termination request; and
wherein the voice call receiver is to receive a confirmation of the termination request before the predetermined response is transmitted.

25. A telephone according to claim 23, wherein the predetermined response is a text message.

26. A telephone according to claim 25, wherein the one or more selectable predetermined responses comprise one or more text messages.

27. A telephone according to claim 26, wherein the one or more selectable predetermined responses comprise one or more voice messages.

28. A telephone according to claim 25, wherein the predetermined response is a voice message.
